(19) United States
(12) Patent Application Publication
(10) Pub. No.: US 2009/0120823 A1
(43) Pub. Date: May 14, 2009

(54) TRAY PALLET

(75) Inventor: Vance L. Seagle, Henderson, NV (US)

Correspondence Address: FLIESLER MEYER LLP, 650 CALIFORNIA STREET, 14TH FLOOR, SAN FRANCISCO, CA, 94108, US

(73) Assignee: AIRDEX INTERNATIONAL, INC., Henderson, NV (US)

(21) Appl. No.: 12/269,728

(22) Filed: Nov. 12, 2008

Related U.S. Application Data
(60) Provisional application No. 61/002,996, filed on Nov. 13, 2007.

(51) Int. Cl. B65D 19/04; B65D 19/38; G08B 13/14; B29C 51/08

(52) U.S. Cl. 206/386; 206/557; 206/524.3; 206/459.1; 340/572.1; 264/322

(57) ABSTRACT

The present invention provides a lightweight, thermally insulating tray pallet for retaining cargo in place and preventing damage of the cargo loaded on the corners of the pallet. The tray pallet simplifies the manufacturing process and reduces the weight of the pallet by requiring stretching only a single thermoplastic sheet over an expanded polymer core. The strength of the tray pallet can be increased by applying a thicker thermoplastic sheet over the expanded polymer core.

### PRIORITY CLAIM

This application claims priority to U.S. Provisional Patent Application Ser. No. 61/002,996, entitled: “TRAY PALLET”, inventors: Vance L. Seagle, filed Nov. 13, 2007.

### FIELD OF THE INVENTION

This invention is in the general field of load-bearing pallets and, more particularly, is a light load bearing pallet made from a core that is chemically combined with a single thermoplastic sheet wherein a tray is formed to help contain and protect air freight cargo.

### BACKGROUND OF THE INVENTION

Wooden containers capable of being assembled on wooden palates can be made to suit the shipping load. The wooden container can be reinforced to suit the load, using blocking & bracing. A wooden container of standard dimension 1219 mm (48 inches)×1016 mm (40 inches)×1016 mm (40 inches) typically weighs 350-400 lbs.

Deleterious factors associated with wooden shipping containers include injuries caused by wood splinters and nails to people who handle the wooden container. Additionally, disposal of the wooden container at the end of its useful life has negative consequences for the environment.

The adoption of International Standardized Phytosanitary Monitoring (ISPM)-15 for wood packaging material (WPM) requires treatment of kiln drying of all wood in shipping containers. The United States in cooperation with Mexico and Canada began enforcement of the ISPM 15 standard on Sep. 16, 2005. The North American Plant Protection Organization (NAPPO) strategy for enhanced enforcement was fully implemented on Jul. 5, 2006, with full enforcement on all articles of regulated WPM entering North America. Non-compliant Regulated WPM is not allowed to enter the United States. The adoption of ISPM-15 reflects the growing concern among nations about wood shipping products enabling the importation of wood-boring insects, including the Asian Long horned Beetle, the Asian Cerambycid Beetle, the Pine Wood Nematode, the Pine Wilt Nematode and the Anoplophora Glapripwnnis.

On Apr. 26, 2007, the Californian Air Resources Board issued an Airborne Toxic Control Measure (ATCM) to Reduce Formaldehyde Emissions from Composite Wood Products. The ATCM would apply to panel manufacturers, distributors, importers, fabricators, and retailers of hardwood plywood (HWPW), particleboard (PB), and medium density fiberboard (MDF), and finished goods containing those products, that would be sold or supplied to California. The ATCM establishes two phases of formaldehyde emission standards, measured by the American Society for Testing and Materials (ASTM) test E 1333-96, for HWPW with a veneer core (HWPW-VC) and with a composite core (HWPW-CC), PB, MDF, and thin MDF. Complying materials must be used in finished goods made with those materials. The first phase, which begins 2009, sets limits on the parts per million of formaldehyde in composite core HWPW of 0.08 and PB of 0.18. The second phase which begins 2011-2012 lowers these limits to 0.05 and 0.09 ppm respectively. The standards apply to domestic and imported products. Thus, the use of composite core HWPW and PB to form the deck in wood pallets in California would be severely restricted. Additionally, any use of these materials would require testing and third party certification.

Thus the wooden dunnage platform has become unattractive for the shipment of products. In addition, the wooden shipping container does not protect the shipment from accidental damage or theft as a result of accidental or intentional damage to the shipping containers. The construction of wooden containers allows viewing of the products being shipped, which can allow a thief to target particular products. Any wood furring strips used to seal surfaces or cracks in wooden containers and thereby conceal the identity of the product being shipped must also meet the ISPM-15 requirements.

Plastic shipping containers, constructed with plastic are known, see U.S. Pat. No. 3,915,089 to Nania, and U.S. Pat. No. 6,216,608 to Woods et al. These hard shell plastic shipping containers use no wood products and are very strong. However, they are relatively heavy (48″×40″×40″ is typically 100-600 lbs depending on the container type, e.g., a frame with minimal siding versus a container with structural integrity) and are expensive to manufacture. In general, because one piece molding is employed with plastic shipping containers, they cannot be ‘knocked-down’ or otherwise disassembled prior to return to the shipping point of origin or other appropriate destination. As a result these plastic shipping containers have a 1:1 shipping to return ratio. That is the return of the empty container requires just as much space as the original container shipment with the product.

Some shipping container manufacturers have attempted to produce a more sanitary surface by combining foam with wooden surfaces. These containers still suffer a number of disadvantages including their weight, the presence of wood requiring treatment, and their ease of entry for a thief. Further, coating the wood with foam adds the additional disadvantage that the container cannot be easily knocked down or disassembled for return to the shipping point of origin or other appropriate destination.

Thermoplastic molding is used to create a wide variety of useful articles. In general, the process of thermoplastic molding involves heating a thermoplastic material to its glass transition temperature, at which point the material become pliable, molding the pliable thermoplastic into the shape of a desired article and allowing the article to cool. Once a thermoplastic material cools to a temperature beneath the range of its glass transition temperature the material become significantly less pliable and maintains its new shape. A number of processes have been developed for shaping thermoplastics including single and twin sheet thermoforming.

Thermoplastics can be used to laminate various articles including load-bearing structures. U.S. Pat. No. 5,833,796 to Matich, which is herein incorporated by reference in its entirety, involves applying thermoplastic sheets to a preformed rigid structure. The structural component is essentially rigid and a thermoplastic skin is applied to either one or both sides of the structural component. U.S. Pat. No. 5,833,796 to Dummett, which is herein incorporated by reference in its entirety, discloses applying thermoplastic sheets to a preformed rigid structure for manufacturing dunnage platforms.

Further, irrespective of whether the load bearing structures are made of wood, plastic, foam or thermoplastic, they are a source of fuel for a fire and thus represent a fire hazard. Storage of pallets after unloading, either inside or outside the delivery location increases the risk of a significant fire. Flame retardant materials are known, however, they have not been successfully incorporated into pallet construction materials. Thus there is a need for a pallet which is light, cheap and does not present a fire hazard. Since materials being shipped can also represent a fire hazard, while somewhat beneficial, it is not essential that the pallet per se be fire resistant. However, there is a need for a method of storing, loading, dispensing and shipping empty pallets, which are light, inexpensive and not a fire hazard.

### SUMMARY OF THE INVENTION

In an embodiment of the invention, a tray pallet made up of a light weight core laminated with a single thermoplastic sheet forms a tray top with the deck top of the core remaining optionally exposed. This embodiment of the invention has the multiple advantages that it allows the tray to contain and hold the cargo located in the tray, to protect the cargo when strapped to the pallet from damage by the strapping, to minimize manufacturing of the tray pallet in as much as the process requires only a single thermoplastic sheet to be drawn over the core and holder (or mold) and to reduce costs. In one embodiment of the invention, the walls of the tray top extend approximately 0.03 m (1.2 inches) above the deck surface. In another embodiment of the invention, the walls of the tray top extend approximately 0.06 m (2.4 inches) above the deck surface. In an alternative embodiment of the invention, the walls of the tray top extend approximately 0.15 m (6 inches) above the deck surface. In various embodiments of the invention the corners of the tray are square so as to allow the tray to pack the maximum amount of cargo within the tray. The tray pallet provides added protection for cargo transported on a pallet. Upon delivery and unloading, the empty tray pallet can be stacked to reduce the volume of the tray pallets for storage or further shipment.

The tray pallet allows for the coating without requiring a formaldehyde adhesive as is required with many wood and plastic pallets. The tray pallet has additional advantage of allowing surface treatment of the deck such as ‘embossing’, ‘texturing’, ‘labeling’, ‘printing’, ‘bagging’, ‘partitioning’ or ‘pressing’ into the surface’ and ‘customized shape beds or pockets’ for securing cargo, all without the use of formaldehyde or other toxic substances.

The manufacture of articles by twin sheet thermoplastic molding often involves the use of complimentary male and female molding tools. In one common methodology a thin sheet of thermoplastic material is heated until it is pliable, and positioned adjacent to a male mold. The thermoplastic sheet is then moved relative to the tool's surface until the sheet assumes the same shape as the surface of the tool. A second sheet of thermoplastic material is heated until it becomes pliable. The heated second sheet is then centered over the cavity of a female molding tool and moved relative to the female tool molding until the interior portion of the second sheet substantially conforms to the interior shape of the female tool. An advantage in the manufacture of articles by single sheet thermoplastic molding is that the core can be held with a holder from the side which is not coated with the thermoplastic sheet. The holder and/or the core can incorporate one or more devices known to a person of skill including male female connectivity in order to retain the core during the molding process. The corners of the heated sheet that project past the deck after the sheet has conformed to the interior shape of the core can be joined. The joining process can involve pressing or pinching the excess material of one side of the heated thermoplastic sheet to the excess material of another side and thereby affix the two sides. In this manner the tray can be strengthened.

Vacuum-assist molding uses a vacuum to help draw heated thermoplastic sheets into contact with the surface of the tools. Irrespective of how they are formed, after the two thermoplastic sheets have taken on the shapes of the male and female molds, the edges of the sheets are pressed together and welded to form a single article. U.S. Pat. No. 5,641,524 to Rush et al., which is hereby incorporated by reference in its entirety, discloses vacuum-assist thermoplastic molding. An alternative to vacuum molding is plug-assist molding. In plug-assist molding, a rigid tool is used to push a heated sheet at least partly into the cavity of a second tool with a surface shape complimentary to the shape of the first tool. U.S. Pat. No. 6,379,606 to Chun et al., and U.S. Pat. No. 5,641,524 to Rush et al., both of which are hereby incorporated by reference their entirety, describe plug-assist molding. U.S. patent application Ser. No. 10/858,184 (publication number 2005/0260344) to Bearse et al., which is hereby incorporated by reference in its entirety, describes using a compressible core as a plug in the plug-assist molding process. The compressible core member used becomes a part of the manufactured article and helps to strengthen and stabilize the article. The compressible member, as a part of the manufactured article, continues to resist compression. The expansive force exerted by the core member trying to expand against the constraining force exerted by the shell strengthens the bond between the shell and the core.

In various embodiments of the present invention, by requiring only a first thermoplastic sheet, the cost of the machinery to produce pallets can be reduced. In various embodiments of the present invention, by requiring only a first thermoplastic sheet, the manufacturing time to build the pallets can be reduced. In various embodiments of the present invention, by requiring only a first thermoplastic sheet, the cost of manufacturing the pallets can be reduced.

When heating a thermoplastic sheet and stretching the sheet over a holder or mold, it is easier to mold over curved surfaces rather than edges and corners. The Thermoplastic sheet will smoothly follow the contour of a rounded edge and produce a more even distribution of the sheet over the rounded surface. In extreme cases sharp edges are avoided since the thermoplastic sheet will tear rather than stretch over the sharp edge. As a result, when fabricating a pallet by stretching a thermoplastic sheet over a polymer core, the edges of the core are rounded to avoid tearing. As a consequence the pallet edges are rounded. While the curvature of the edge is only slight, it does involve some increased risk that cargo loaded on the pallet will protrude past the pallet circumference and as a result the cargo can be damaged. In an embodiment of the invention, the holder which abuts to the polymer core over which the thermoplastic sheet is stretched has right angled (90 degree) corners. Because the thermoplastic sheet is first drawn over the rounded edges of the polymer core the slight change to square edges of the holder do not result in uneven coverage of the thermoplastic sheet on the holder. Further, the change to square edges reduces the risk of a tear in the thermoplastic sheet when stretching over the holder. As a result the thermoplastic sheet that extends past the polymer core to the holder results in a tray which has right angled interior corners. In addition, the holder is tapered such that the thermoplastic sheet that extends past the polymer core to the holder extends outwards from the pallet deck and forms an outward extending tapered tray. As a result of these improvements, cargo that is packaged in rectangular or square boxes can more easily be located within the tray and can use the maximum loading area of the tray pallet.

Other embodiments of the implants and methods, within the spirit and scope of the invention, can be understood by a review of the specification, the claims, and the figures.

### BRIEF DESCRIPTION OF THE FIGURES

FIG. 1 shows a conventional light weight pallet loaded with cargo in which cardboard supports are used underneath the cargo, on top of the cargo and on each side to protect the cargo;

FIG. 2 shows a side view from above of a tray pallet;

FIG. 3 shows a side view from below of a tray pallet;

FIG. 4 shows a close-up side view from below of a tray pallet;

FIG. 5 shows a side view of a tray pallet;

FIG. 6 shows a side view from above of a tray pallet;

FIG. 7 shows four tray pallets stacked together;

FIG. 8 shows a schematic of the design of the tray pallet, where (A) shows the bottom side of the pallet with strengthening grooves (B) and (C) show profile views of the length and width of the tray pallet, (D) shows a CAD drawing of the bottom side and (E) shows a CAD drawing of the top side of the tray pallet; and

FIG. 9 shows a schematic profile view of access to the tray pallet by of (A) and (B) COMPAL 1 Pallet Jack Entry from the width and from the length, (C) and (D) US Pallet Jack Entry from the width and from the length, (E) storage of the pallet on US racking, (F) and (G) width and length views of loading six (6) tray pallets on a 96″ (P6) Cookie Sheet for air freight.

### DETAILED DESCRIPTION OF THE INVENTION

In one embodiment of the invention, the tray pallet dimensions are 1.219 m (48 inches)×1.016 m (40 inches)×0.1525 m (6 inches). In an alternative embodiment of the invention, the tray pallet dimensions are 1.2 m (47.24 inches)×1.0 m (39.37 inches)×0.15 m (5.9 inches). In various embodiments of the invention, the tray pallet contains only a single thermoplastic sheet covering the legs, the underside and the sides of the core, and forming the tray leaving the top deck of the core uncovered. In an alternative embodiment of the invention, two or more thermoplastic sheets are used wherein the top deck of the core can also be covered and sealed with a thermoplastic sheet.

In various embodiments of the invention, the reduced strength of the pallet due to the use of a single thermoplastic sheet can be compensated for in part by using a thicker width thermoplastic sheet. In various embodiments of the invention, the thickness of the thermoplastic sheet can be 60 mm (2.36 inch). In various embodiments of the invention, the density of the polymer core is 20 g/L. In an embodiment of the invention, the tray pallet with a 60 mm thick high impact polystyrene sheet and a 20 g/L expanded polystyrene core can weigh 8 lbs (3.64 kg). In an embodiment of the invention, the tray pallet with a 40 mm thick high impact polystyrene sheet and a 3.5 g/L expanded polystyrene core can weigh 7 lbs (3.18 kg). In various embodiments of the invention, the tray pallet can be used to load cargo between 300 (660 lbs) and 500 kg (1100 lbs) in weight. It is envisaged, that use of thicker thermoplastic sheets and denser polymer core for strengthening the tray container will add additional strength and additional weight.

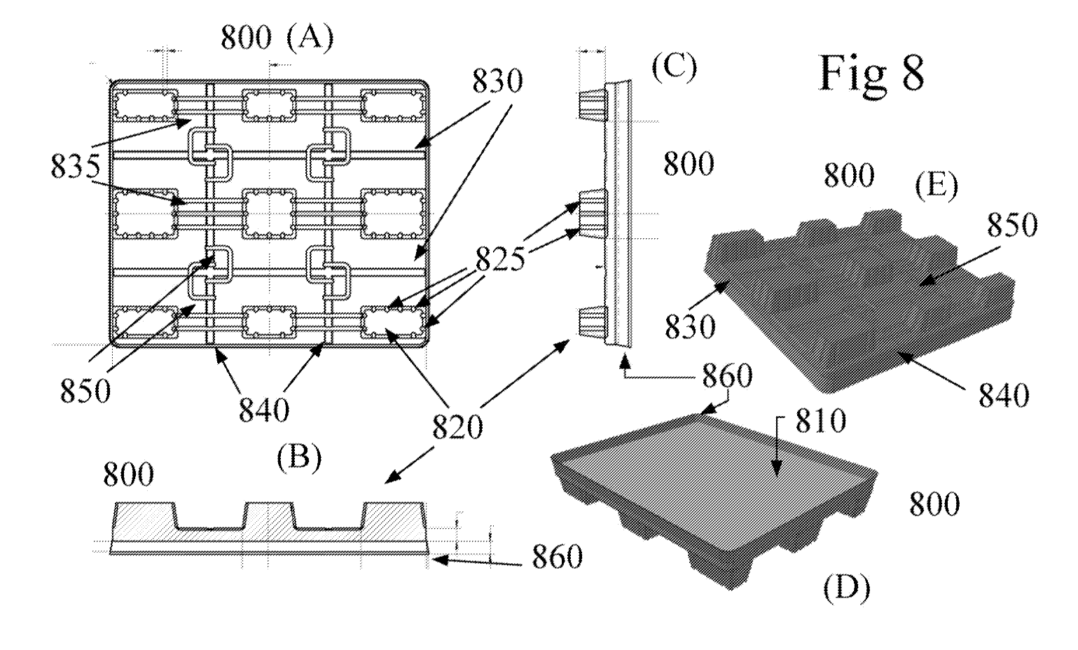

In various embodiments of the invention, two or more recess grooves with dimensions corresponding to the strapping used to strap the cargo to the pallet are formed in either one or both horizontal (longitudinal or major axis) and vertical (lateral or minor axis) directions of the bottom and sides of the core holder such that when the core is formed it has such recess grooves present as shown in FIG. 8. FIG. 8A shows a schematic of the bottom side of the tray pallet 800, with horizontal strengthening grooves running the full length of the tray pallet 830, or horizontal strengthening grooves running between the legs 820, called inter leg grooves 835, vertical strengthening grooves running the height of the legs 820, called intra leg grooves 825, vertical strengthening grooves running the full width of the tray pallet 840 and ‘C’ shaped strengthening grooves 850. FIG. 8B shows the longitudinal profile of the tray pallet 800, where the legs 820 extend from the bottom side and the tray 860 extends from the top side. FIG. 8C shows the lateral profile of the tray pallet 800, where the legs 820 extend from the bottom side, the intra leg grooves 825 extend the height of the legs 820 and the tray 860 extends from the top side. FIG. 8D shows a CAD drawing of the bottom side of the tray pallet 800, with horizontal strengthening grooves running the full length of the tray pallet 830, vertical strengthening grooves 840 and ‘C’ shaped strengthening grooves 850. FIG. 8E shows a CAD drawing of the top side of the tray pallet 800 with the deck 810 and tray 860. Using such a core results in a number of advantages for the tray pallet including that the strapping or banding is hidden so that a fork lift arm doesn't snag the strapping. The recess grooves also increase the strength of the tray pallet. In various embodiments of the invention, the holder used to abut and hold the core when the thermoplastic sheet is stretched over the core can also have recess grooves that match the recess grooves formed in the core so that the strapping or banding doesn't impact the integrity of the pallet cargo.

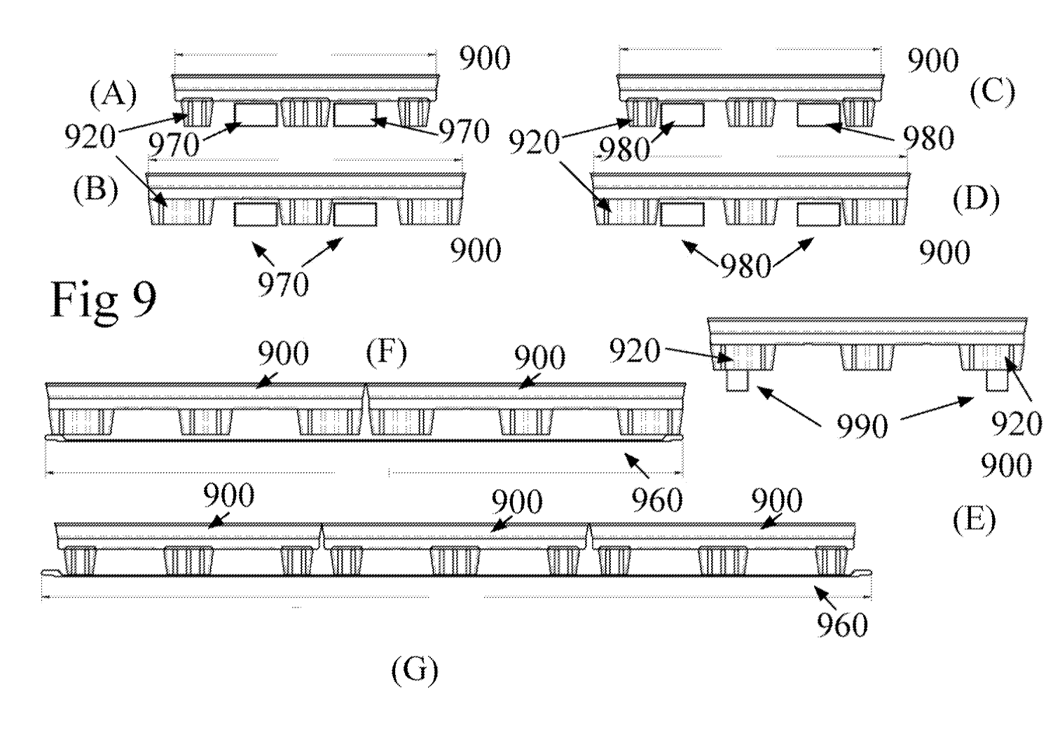

In various embodiments of the invention, two or more sets of opposing ‘C’ shaped recess grooves are formed in the bottom of the core holder (half cylindrical tube type protrusions) such that when the core is formed it has half cylindrical tube type indentations recess grooves present as shown in FIG. 8. The presence of four or more of these ° C.'s in the base of the tray pallet increase the racking strength of the tray pallet in all 4 directions. In various embodiments of the invention, one or more sets of racking grooves running parallel with the major axis and between the legs as shown in FIG. 8, increases resistance to the bending of the tray pallet when stacked (see FIG. 9). FIGS. 9A and 9C show schematic profile views of access to the tray pallet 900 between the legs 920 via the width by COMPAL 1 Pallet Jack Entry 970 and US Pallet Jack Entry 980. FIGS. 9B and 9B show schematic profile views of access to the tray pallet 900 between the legs 920 via the length by COMPAL 1 Pallet Jack Entry 970 and US Pallet Jack Entry 980. FIG. 90E shows the longitudinal profile view of a tray pallet 900 stored on US racking, where the legs 920 are supported on the racking supports 990. In various embodiments of the invention, one or more sets of half cylindrical tube type indentations running up and down and spaced around one or more of the legs (as shown in FIG. 8 see 830, 835, 840 and 850) increase the racking strength of the pallet. In an embodiment of the invention, the deformation monitored for a double sided pallet made with 40 mm high impact polystyrene sheets with a 460 kg load was found to sag in the major axis over 2-3 weeks and then freeze. In an embodiment of the invention, a double sided pallet made with 40 mm high impact polystyrene sheets incorporating (1) strapping grooves, (2) “C” shaped grooves, (3) inter leg grooves and (4) intra leg groove with a 1000 kg (2200 lbs) load was found to sag less than the equivalent pallet without the strengthening grooves and a 460 kg (1012 lbs) load in the major axis over 2-3 weeks and then freeze. In various embodiments of the invention, the tray pallet made with 60 mm high impact polystyrene sheets containing (1) strapping grooves, (2) “C” shaped grooves, (3) inter leg grooves and (4) intra leg grooves can be tested on a closed/open rack load bearing system with a control load to determine pallet integrity over time. In an embodiment of the invention, the tray pallet can be pre-stressed to compensate for the sag freeze behavior.

FIGS. 9F and 9G show the dimensions of the tray pallet are designed to allow maximum loading on an air freight ‘P6’ cookie sheet. FIG. 9F shows the width view of a P6 Cookie Sheet 960 on which two (2) tray pallets 900 fit in the width. FIG. 9G shows the length view of a P6 Cookie Sheet 960 on which three (3) tray pallets 900 fit in the length.

In various embodiments of the invention, the tray pallet can have square interior corners. The holder used to abut and hold the core when the thermoplastic sheet is stretched over the core and holder can have perfect square corners and thereby the tray assumes a perfect rectangle shape to maximize the dimensions of the cargo to be contained and protected.

In various embodiments of the invention, the tray pallet can slope outwardly. The holder used to abut and hold the core when the thermoplastic sheet is stretched over the core and holder can have sides sloping outwards to make help facilitate localizing the cargo in the tray during loading and thereby maximize the dimensions of the cargo to be contained and protected.

In various other embodiments the tray pallet can be custom sized. In another embodiment, an inverted tray pallet can be used as a lid on top of cargo loaded on a tray pallet allowing the cargo and pallets to be strapped together without damaging the cargo. In one embodiment of the invention, the walls of the tray top extend approximately 0.6 m (24 inches) above the deck surface. In another embodiment of the invention, the walls of the tray top extend approximately 0.3 m (12 inches) above the deck surface. In an alternative embodiment of the invention, the walls of the tray top extend approximately 0.15 m (6 inches) above the deck surface. In another alternative embodiment of the invention, the walls of the tray top extend approximately 25 mm (1 inch) above the deck surface. In still another embodiment the length, width and height dimensions of the tray pallet can all be modified from the standard dimensions. In a further embodiment of the invention, the dimensions of the tray pallet can be modified to meet the Returnable Plastic Container (RPC) requirements.

In one embodiment of the invention, the tray pallet can be made from an Expandable Polystyrene (PSE) core chemically combined with a single High Impact Polystyrene (HIPS). Because of a chemical combination of components, comparing the core before the chemical combination to the double sheet tray pallet that is formed, there is an increase in strength to weight ratio of as much as 1000:1.

In various embodiments of the invention, the core material can be a blend of polyphenylene ether (PPE) and polystyrene (PS) impregnated with pentane, or a blend of polyyphenyene ether (PPE) and polystyrene (PS) impregnated with pentane or a blend of polyethylene (PE) and Polypropylene.

In various embodiments of the invention, the core material can incorporate one or more agents selected from the group consisting of insecticide, bactericides and fungicides to inhibit growth of bacteria, mould and fungal growth. In alternative embodiments of the invention, the core material can incorporate one or more agents selected from the group consisting of water proofing agents, leak proof agents and non-slip agents to inhibit trapping of water or other liquids and to inhibit cargo from slipping once loaded onto the tray pallet. In an embodiment of the invention, the insecticide, bactericide, fungicide, water proofing agent, leak proof agent or non slip agent is a surfactant film sprayed or otherwise applied to either the exposed polymer core deck or the tray pallet. In an embodiment of the invention, the insecticide, bactericide or fungicide is DuPont™ Kocide® 3000. In another embodiment of the invention a fungicidal agent selected from copper, zinc, cadmium, nickel and/or cobalt salts of N-nitroso-N-cyclohexylhydroxylamine can be incorporated into the surface chemical structure of the thermoplastic sheet by delivering an approximately 1 mM to 1M aerosol spay of the fungicidal agent directed at the heated thermoplastic sheet after the tray has been formed, wherein the fungicidal agent is incorporate into the thermoplastic sheet as it cools. In another embodiment of the invention a bactericidal agent selected from glucose, fructose, glucuronic acid polymers can be incorporated into the surface chemical structure of the thermoplastic sheet by delivering an approximately 1 mM to 1M aerosol spay of the bactericidal agent directed at the heated thermoplastic sheet after the tray has been formed, wherein the agent is incorporate into the thermoplastic sheet as it cools. The agent can be diluted using one or more solvents selected from the group consisting of water, methanol, ethanol, formaldehyde, acetaldehyde, formic acid, acetic acid and acetone.

Atom transfer radical polymerization can be used to introduce a super-hydrophobic water resistant surface onto the tray pallet. A polymerization initiator, 2-bromoisobutyryl bromide in the presence of tetraethyl ammonium and 4-Dimethylaminopyridine (DMAP) in tetrahydrofuran (THF) at room temperature (RT), can be attached onto one or more of the tray pallet exposed surfaces. Glycidyl methacrylate, an epoxide monomer in the presence of CuCl, CuBr₂ and N,n,n′,n′,n-Pentamethyldiethylenetriamine in toluene at 30° C. can next be grafted onto the one or more treated surfaces. Ring-opening of the epoxide groups, can be affected by aqueous hydrochloric acid treatment in the presence of THF at RT. The resulting hydroxyl groups can be reacted with pentadecafluorooctanoyl chloride in the presence of tetraethyl ammonium, DMAP and dichloromethane at RT to create the super-hydrophobic surface.

The super-hydrophobic surface allows the entire tray pallet to be easily cleaned, helping to insure that organic material or residues do not become associated with the tray pallet.

A non-slip surface on the tray pallet deck can be introduced by spraying (cross head speed of approximately 10²-10⁴ m/minute) or otherwise applying high temperature (200-300° F.) silica particles (approximately 10⁻⁶-10⁻³ m) to the polymer core deck surface and allowing the impacted surface to cool. Sand particles proximal to the polymer core which result in micro heating of the polymer core can become partially impregnated into the polymer core resulting in a rough surface. In an alternative embodiment of the invention, the sand impregnated deck surface can be sealed with a coating. In an alternative embodiment, the sand impregnated surface can be treated to produce a super-hydrophobic non-slip surface.

The deck surface of the tray pallet can be labeled with advertising or instructions. In an embodiment of the invention, the label can be attached to the core by an adhesive. In an alternative embodiment of the invention, the label can be pressure applied to the deck surface. The label attached to the surface of the holder on which the core is held can have the reverse side of the label attached so that the pressure of the stretching process can be used to permanently apply the label to the deck. Advertising or instructions can also be embossed onto the polymer core through negative printing. In an embodiment of the invention, the holder surface contains the negative image of the message to be embossed. During the drawing of the thermoplastic film over the polymer core, the pressure supplied between the holder and the core is sufficient to emboss the core deck with the message.

The deck surface of the tray pallet can have depressions pressed into the deck to help retain the cargo and minimize shifting with transport. The tray can be separated or segmented by embossing depressions into the polymer core to help with loading or securing cargo. The deck surface can hold a bag more securely through ‘bagging’. The deck surface because it has walls would hold a bag, containing liquids, ice or round objects. The rough surface could also be used to help retain the bag within the tray.

The tray can act to protect the cargo by lifting the straps that are used to secure the cargo to the tray pallet away from the cargo, to minimize chaffing and rubbing. In an embodiment of the invention, spacers are used on top of the cargo to prevent the straps from chaffing or rubbing the cargo. In an alternative embodiment of the invention, by positioning the cargo onto a tray pallet and placing a second tray pallet on top of the cargo the cargo can be secured by straps that do not come into contact with the cargo.

In various embodiments of the invention, the thermoplastic sheets used to cover the core can be either polypropylene/polypropylene composite, Polycarbonate (PC), Low Density Polyethylene (LDPE), High Density Polyethylene (HDPE), acrylics, ABS, PVC, polycarbonate, acetate, terephthalate, polystyrene, Polypropylene (PP), and Polyphenyl ether alloyed with High Impact Polystyrene. In various alternative embodiment of the invention, the thermoplastic sheet material can be a heterogeneous/homogeneous copolymer mixture to increase the impact strength and tear resistance of the film. U.S. Pat. No. 6,984,695 to Brown entitled “Heterogeneous/Homogeneous Copolymer” which is incorporated by reference in its entirety describes polyethylene copolymers with such improved properties.

In embodiments of the invention, the thermoplastic sheets are flame retardant. U.S. Pat. No. 6,998,433 to Overholt entitled “Flame retardant polyolefin pallets and flame retardant master batch for their production” which is incorporated by reference in its entirety describes poly-olefins containing magnesium hydroxide, and optionally alumina tri-hydrate, and zinc borate with such improved properties. In an alternative embodiment of the invention, the flame retardant activity can be a property of the polymer such as polyether terephthalate (PET). In another embodiment of the invention, the flame retardant activity can be due to a film applied to the surface of the tray pallet.

In one embodiment, the bottom or under side (the side with legs) of a compressible core member is introduced and stretched over a single heated thermoplastic sheet. Alternatively, a holder can be used to abut and hold the core while the thermoplastic sheet is stretched over the core. The holder can be attached to the core using a turn key type lock. After stretching of the thermoplastic sheet over the core and the holder, the turn key lock can be disengaged and the holder removed. In various embodiments of the invention, either before removal of the holder or after, the thermoplastic sheet can be cut and welded to seal a tray in the thermoplastic sheet surface. The tray pallet produced using this procedure does not require two thermoplastic sheets and therefore saves materials compared with a conventional thermoplastic pallet. The weight of the tray pallet is also reduced by not using two thermoplastic sheets. The production of the tray pallet also saves in production time and resources since only a single cutting and welding of the thermoplastic sheet is required. In various embodiments of the invention, the thickness of the thermoplastic sheet can be increased to offset any reduction in strength of the tray pallet which results from the elimination of the second thermoplastic sheet. In these embodiments the thicker thermoplastic sheet's weight will reduce any weight savings from eliminating the second thermoplastic sheet.

In another embodiment, the top side of a compressible core member is introduced and a first heated thermoplastic sheet stretched over the core. The thermoplastic sheet surface is then cut to the width of the side of the core. Next, the bottom side of the compressible core member is introduced and sandwiched between a second heated thermoplastic sheet. The sandwich is compressed and corresponding portions of the two sheets contact one another and bond together. The core member bonds to the interior surface of the thermoplastic shell as the core member tries to expand and contacts portions of the thermoplastic shell. The thermoplastic sheet is then cut and welded to seal a tray in the thermoplastic sheet surface. The advantage of this double sheet thermoplastic sheet with tray is that it is sealed for use in transporting food stuffs.

In an alternative embodiment of the invention, a first heated thermoplastic sheet is sandwiched between two compressible core members, where the thermoplastic sheet is stretched around a cubic core member and the deck of the second core member which contains legs. Subsequently, the thermoplastic sheet is then cut and welded to seal a tray in the thermoplastic sheet surface above the cubic core.

In one embodiment of the invention, the cargo is loaded on a tray pallet and another tray pallet is inverted and placed on top of the cargo. After strapping the cargo this allows stacking of another tray pallet onto the inverted tray pallet and therein a second cargo to be loaded.

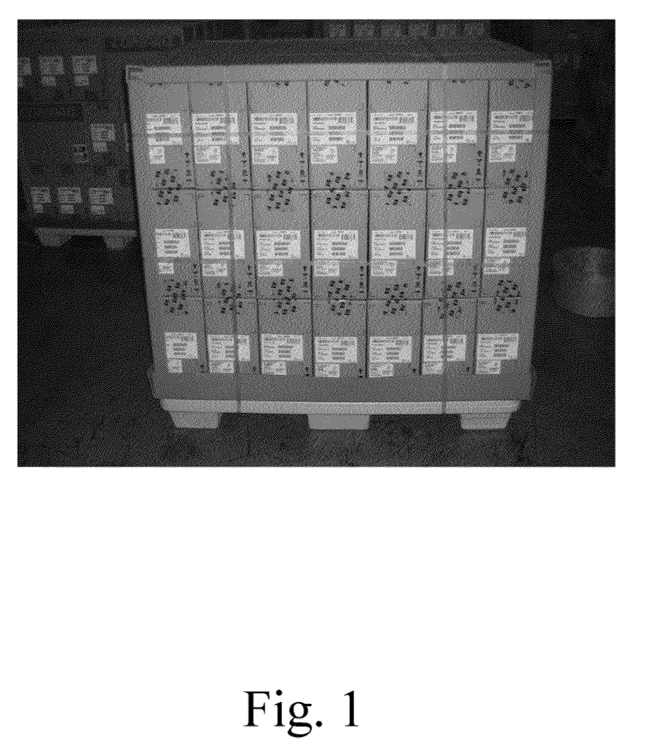

FIG. 1 shows a conventional light weight pallet. When the conventional light weight pallet is loaded with cargo, corrugated cardboard supports are used underneath the cargo, on top of the cargo and on each side to protect the cargo. The cardboard and the strapping are used to hold the cargo on the pallet and to help protect the edges from damage.

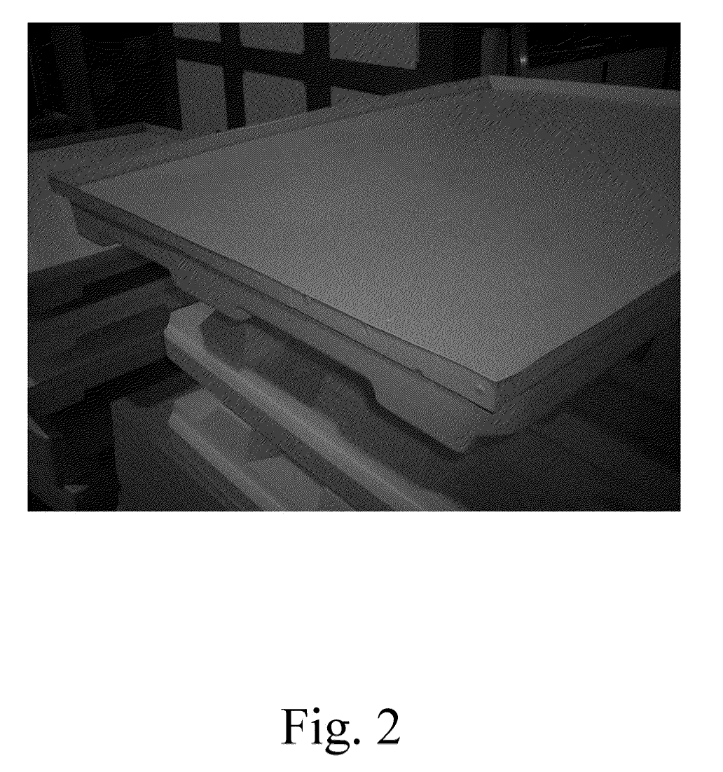

FIG. 2 shows a tray pallet made from High Impact Polystyrene (HIPS) chemically combined on the lower side and sides with an expandable polystyrene (EPS) core. In this embodiment of the invention, the walls of the tray extend approximately 25 mm (1 inch) above the deck surface. In FIG. 2 the deck of the EPS core has not been combined with HIPS. The tray of the tray pallet provides added protection for cargo transported on a pallet.

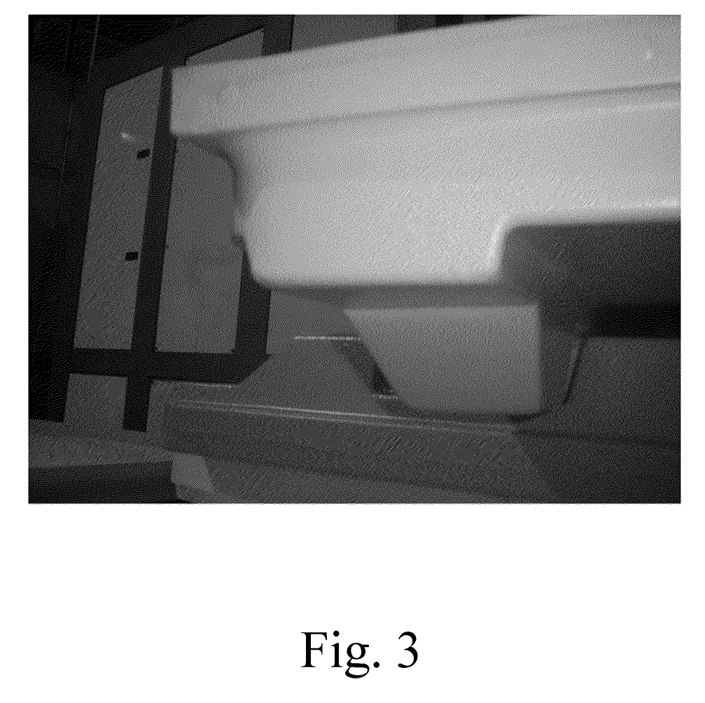

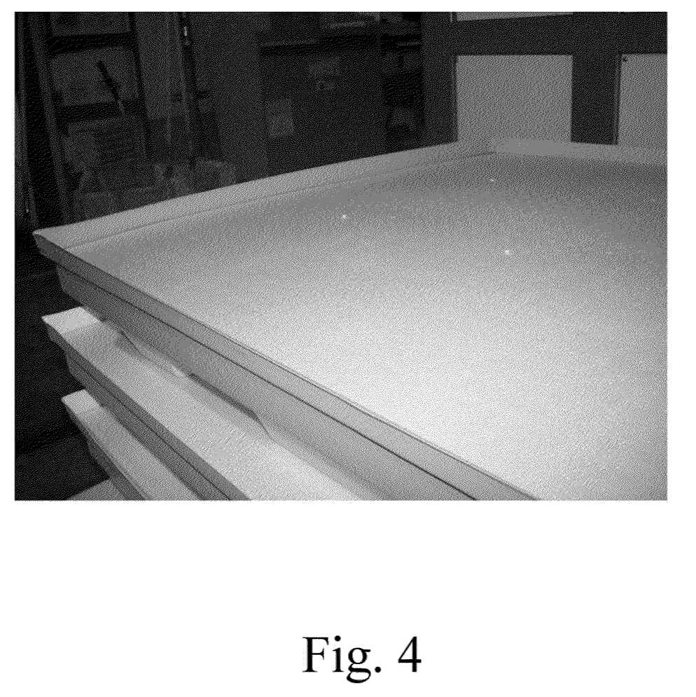

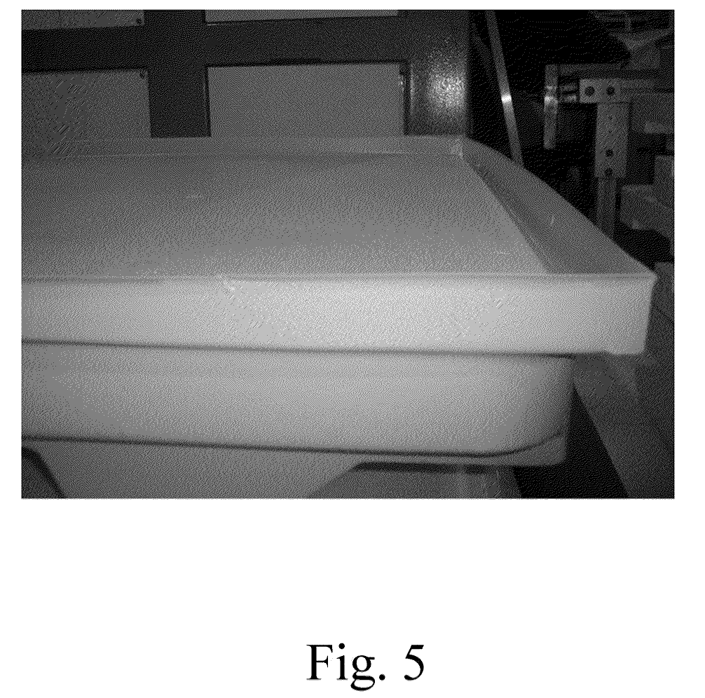

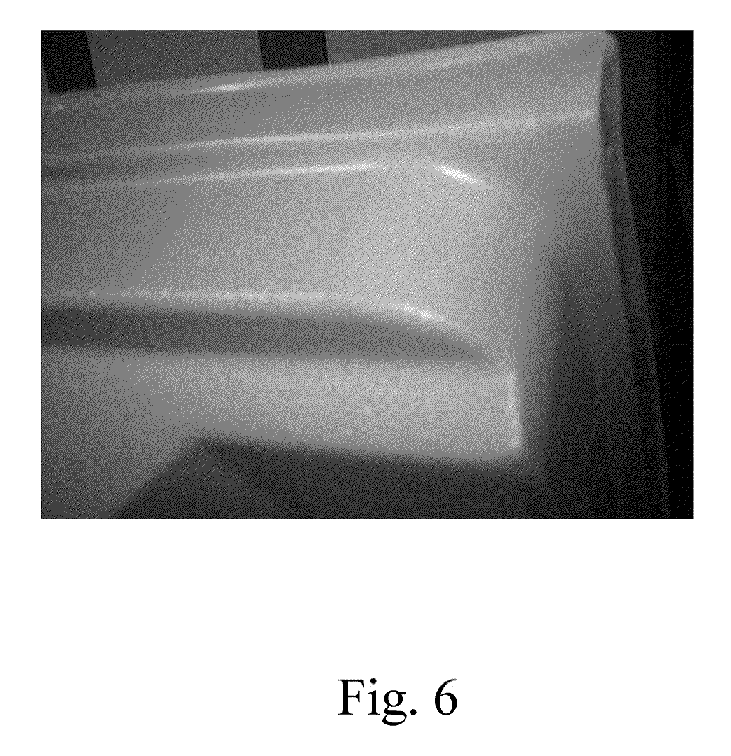

FIG. 3 shows that the tray pallet can be used to load a cargo (foreground) or inverted and used as the top to a cargo when strapping down the cargo. FIG. 4 shows the square corners of the tray pallet as viewed from the underside which protect the corners of the cargo. FIG. 5 shows the square corners of the tray pallet as viewed from the above which allow square shaped cargo boxes to fit within the tray. FIG. 6 shows that the ‘naked’ polystyrene core and the square corners of the tray pallet which allow square shaped cargo boxes to fit within the tray.

In an embodiment of the invention, by requiring only a single thermoplastic sheet to be stretched over an expanded polymer core the manufacture of the tray pallet is considerably simpler and cheaper to manufacture than a normal light weight dunnage platform made from two thermoplastic sheets combined with an expanded polymer core. In an embodiment of the invention, the thickness of the thermoplastic sheet can be increased to increase the strength of the tray pallet. Any increased weight of the thicker thermoplastic sheet is more than offset by the elimination of the need for a second thermoplastic sheet in the construction of the tray pallet. In an embodiment of the invention the tray pallet is stronger and lighter than a light weight dunnage platform. In addition, because the tray pallet requires only a single trim of the thermoplastic sheet and welding to form the tray it requires less time to manufacture than a light weight dunnage platform.

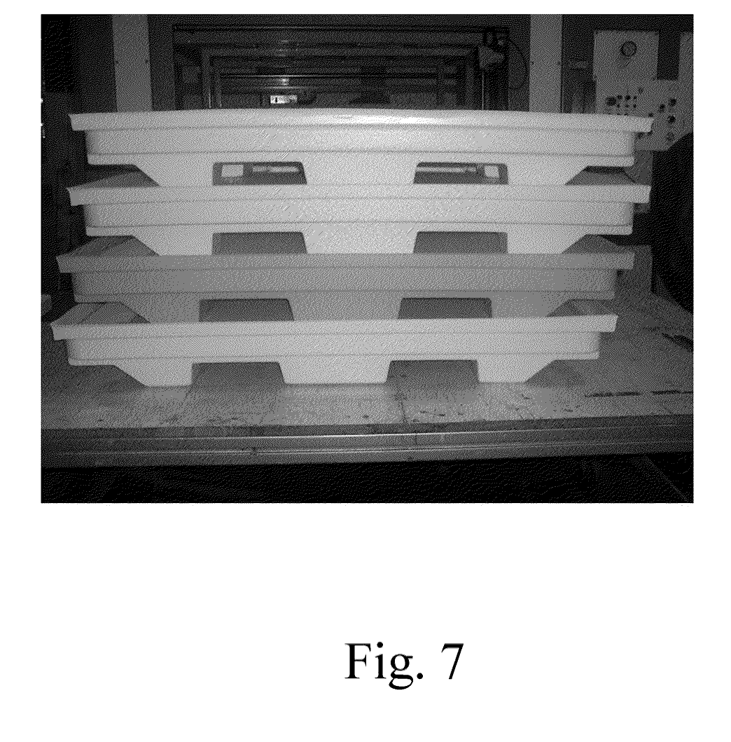

FIG. 7 shows the empty pallets are stackable. Upon delivery and unloading, the tray pallet can be stacked to reduce the volume of the tray pallets for storage or further shipment. A plurality of tray pallets with tray sides less than 100 mm (4 inches) in height are efficiently stackable, however trays heights in excess of 100 mm (4 inches) can be stacked.

In an embodiment of the invention, the tray pallets can be stacked and stored in a bag that is light weight, strong, made of a fire retardant material and which forms an ultra violet light, weather and dust particle barrier to protect the integrity of the tray pallets when not in use. By storing the tray pallets in a bag, the risk of fire can be significantly minimized while the tray pallets are not in use. In one embodiment the bag is attached to a transporter base to enable the tray pallets to be transported to different locations. In an alternative embodiment of the invention, the bag is attached to a dispenser base to enable the tray pallets to be dispensed when required for use in loading a cargo. In another embodiment of the invention, the bag is attached to a reloader base to enable the tray pallets to be loaded into the bag for storage after a cargo has been unloaded. In another alternative embodiment of the invention, the bag is attached to a hoist to enable the bag to be hung from a spreader and thereby the empty tray pallets efficiently and safely stored when not in use. In an alternative embodiment of the invention, the bag can be folded concertina style for storage or shipping of the bag with minimal space requirements. In various embodiments of the invention, different features selected from the group consisting of particle barrier, light barrier, fire retardant, minimal shipment size, transporting base, dispensing base, reloading base and storing spreader and hoist are incorporated into one bag.

In one embodiment of the invention, wheels attached to a transporter base allow the base and bag to be rolled in the direction of its longitudinal axis. In another embodiment of the invention, the wheels can be fixed in an orientation where their axis of rotation is perpendicular to the width of the base frame, which allows the base to be rolled perpendicular to the direction of its longitudinal axis. In an alternative embodiment of the invention, two or more wheels are not fixed in an orientation or are able to swivel, allowing greater flexibility in the direction in which the base can be rolled. In one embodiment of the invention, the base has two wheels attached at two corners and two supports at the other two corners, which enable the bag to be tilted and the base and bag to be wheeled about on the two wheels.

In one embodiment of the invention, the transport base frame can be used to dispense dunnage platforms. A dunnage platform bag can be attached to a transport base frame and inserted in a dispenser base frame. In one embodiment of the invention, the dunnage platforms can be re-loaded using a reloading base. In an alternative embodiment of the invention, the base frame allows dunnage platform dispensing and dunnage platform loading.

In one embodiment of the invention, the bag is made of one or more materials selected from the group consisting of Low Density Polyethylene (LDPE), High Density Polyethylene (HDPE) and polypropylene (PP). In another embodiment of the invention, the bag is made of flame retardant material. In an embodiment of the invention, the bag is made from polyethylene, aromatic bromine and antimony trioxide. In one embodiment of the invention, the bag is made of one or more of the following materials: LDPE, HDPE and PP and treated with ARX 501 FR 05 LD. In an embodiment of the invention, the bag meets standards DIN 4102 B2, DIN 4102 B1 and CEE. In a further embodiment of the invention, the bromine additive is heat stable up to 350° C. This application incorporates by reference in its entirety U.S. application Ser. No. 11/675,049 to Seagle et al. entitled “Light Weight, Strong, Fire Retardant Dunnage Platform Bag and System of Loading, Dispensing and Using Bag”.

In another embodiment of the invention, a Radio Frequency IDentification (RFID) transponder or tag is imbedded in the core of the tray pallet. In another embodiment of the invention, a RFID tag is imbedded in one or more of: the spreader, the transporter base frame, the dispenser base, the reloading base and the material of the four walls of the bag. An RFID system in addition to the tag can include a radio frequency (RF) tag reader, which communicates with the transponder. In particular, the RF transponder, in response to a wireless interrogation signal transmitted by the RF tag reader via an antenna, wirelessly transmits an identification code back to the RF tag reader, which decodes the code and sends it on to a host computer for identification of the device. RF transponders can either be passive, semi-passive, or active. Passive transponders parasitically obtain operating power from the wireless signal transmitted by the RF tag reader, whereas semi-active and active transponders obtain their power from on-board batteries. Because the passive RF transponder chips do not have the range necessary to activate in response to wireless signals received from the RFID reader a few feet away, the range of the RF transponder chip must be increased by either coupling an external portable power source in the form of a battery to the RF transponder chip (basically transforming it into a semi-passive or active transponder), or coupling a high gain antenna to the RF transponder chip. The use of a battery contributes only a slight increase to the weight of the tray pallet or the tray pallet bag, and where any leakage over time results in minimal damage. However, batteries have a limited life, and thus, the efficacy of the RF transponder chip will be lost over time if embedded in the core. The other option is to retain a passive RFID transponder chip but coupling the chip to a high gain antenna within the tray pallet or the tray pallet bag, where the space available for incorporating an antenna is relatively large.

In alternative embodiments of the invention, the RFID tag operates using an Ultra High Frequency (UHF) signal. In another embodiment of the invention, the RFID tag operates using a microwave frequency signal.

In one embodiment, the RFID tag is centered in the middle of the core prior to the lamination of the bottom and sides of the core with the thermoplastic sheet. In another embodiment, the RFID tag is placed on the edge of the core prior to the lamination of the core with the thermoplastic sheet. In another embodiment, the RFID tag is placed in a leg of the core prior to the lamination of the core with the thermoplastic sheet. In another embodiment, the RFID tag is placed in the pallet after the lamination of the core with the thermoplastic sheet so that the sensing is more easily facilitated. In an embodiment of the invention, the RFID tag is placed in the same position in all pallets produced.

In one embodiment the RFID tag is read only. In another embodiment, the RFID tag contains an Electrically Erasable Programmable Read-Only Memory (EPROM), which enables both read and write functions. In an embodiment of the invention, the RFID tag is passive. In another embodiment of the invention, the RFID tag is semi passive containing a source of energy such as a battery to allow the tag to be constantly powered. In a further embodiment of the invention, the RFID tag is active, containing an internal power source, such as a battery, which is used to power any Integrated Circuit's (ICs) in the tag and generate the outgoing signal. In another embodiment, the RFID tag has the ability to enable location sensing through a photo sensor.

In one embodiment of the invention, a cellular modem is imbedded in the core of the tray pallet. The cellular modem can be a Code Division Multiple Access (CDMA) modem. In an embodiment of the invention, a RFID reader and associate integrated circuit processor are embedded together with the cellular modem in the core of the tray pallet. In such an embodiment, the RFID tags and RFID reader are positioned to optimize the RFID read of the RFID tags from other tray pallets.

In an embodiment of the invention, where a RFID reader and a cellular modem are embedded in the core of the tray pallet, the RFID reader is in communication with one or more of the RFID tags of one or more tray pallets in the vicinity of the RFID reader. The RFID reader and associated integrated circuit processor are able to distinguish the RFID tag from different tray pallets based on one or more of location, strength of signal, variation of RFID tag signal with time and prior input data. In an embodiment of the invention, the RFID reader and associate processor are in communication with the embedded cellular modem. In an embodiment of the invention, the cellular modem is in communication with a base station and can transmit one or more parameters selected from the group consisting of one or more RFID tag location, one or more RFID tag identification code, shipment information, shipment condition, shipment container condition, time stamp.

In one embodiment of the invention the RFID code uses the IEEE format and is Electronic Product Code (EPC) readable. In another embodiment of the invention the RFID code uses the UCC format and is Universal Product Code (UPC) readable. In another embodiment, the format is compatible for EPC, European Article Number (EAN) and UPC read and write functions.

What is claimed is:

1. A pallet with a tray for retaining cargo during loading and transporting comprising:
a polymer core including a top deck, a plurality of sides and a bottom with three or more legs attached to the bottom;
substantially surrounding the bottom, the legs and the plurality of sides with a single thermoplastic polymer sheet; and
the tray for retaining cargo; wherein the tray is formed from the single thermoplastic polymer sheet extending a distance D above the deck, wherein one or more thermoplastic polymer sheet corners add strength to the tray, wherein the tray has sufficient strength to retain the cargo on the deck of the pallet.

2. The tray pallet of claim 1, wherein the polymer core is expanded polystyrene.

3. The tray pallet of claim 2, wherein the expanded polystyrene core has a density between:
a lower limit of approximately 10 kg/L; and
an upper limit of approximately 40 kg/L.

4. The tray pallet of claim 1, wherein the thermoplastic sheet is a high impact polystyrene sheet.

5. The tray pallet of claim 4, wherein the high impact polystyrene sheet width is between:
a lower limit of approximately 50 mm; and
an upper limit of approximately 100 mm.

6. The tray pallet of claim 1, wherein the tray has four sides and four interior corners, wherein the four interior corners are pinched together to form right angles.

7. The tray pallet of claim 1, wherein the distance D is between:
a lower limit of approximately 10 mm; and
an upper limit of approximately 300 mm.

8. The tray pallet of claim 1, wherein the tray is rectangular, wherein the four interior corners are between:
a lower limit of approximately 80 degrees; and
an upper limit of approximately 100 degrees.

9. The tray pallet of claim 1, wherein the tray flares outwards from the deck.

10. The tray pallet of claim 1, further comprising means for strengthening the pallet, wherein the means for strengthening includes three or more of the means for strengthening selected from the group consisting of one or more horizontal strapping grooves, one or more vertical strapping grooves, one or more pair of ‘C’ section grooves, inter leg grooves and intra leg grooves.

11. The tray pallet of claim 1, wherein the tray pallet can be used to transport a cargo of maximum weight between:
a lower limit of approximately 300 kg; and
an upper limit of approximately 400 kg.

12. The tray pallet of claim 1, further comprising treating or otherwise incorporating into the chemical structure of one or both the exposed polymer core deck and the tray pallet exterior surfaces, one or more agents selected from the group consisting of a bactericide, an insecticide and a fungicide.

13. The tray pallet of claim 1, further comprising a processor and a RFID tag reader, wherein the processor is in communication with the RFID reader, wherein the RFID reader is able to read one or more RFID tags of one or both the cargo loaded on the tray pallet and one or more tray pallets in an area surrounding the tray pallet.

14. The tray pallet of claim 13, wherein the processor receives one or both of operator input information and RFID tag reader scanned information about the condition of one or both the cargo loaded on the tray pallet and one or more tray pallets in an area surrounding the tray pallet.

15. The tray pallet of claim 13, wherein the processor is able to distinguish between a RFID signal from one or more RFID tags of one or more cargo items loaded in the tray pallet and a RFID signal from a RFID tag of one or more cargo items not loaded in the tray pallet, wherein the processor is able to distinguish the RFID signal based on one or more parameters selected from the group consisting of RFID tag location, RFID tag identification code, shipment information, time stamp and changes in RFID tag location with time stamp.

16. The tray pallet of claim 13, further comprising a portal in contact with the processor, wherein the portal is in communication with a base station, wherein the portal transmits to the base station one or more parameters selected from the group consisting of one or more RFID tag location, one or more RFID tag identification code, tray pallet information, cargo condition, tray pallet condition, time stamp and changes in RFID tag location with time stamp.

17. The tray pallet of claim 1, wherein the pallet is pre-stressed to minimize bending in the major axis.

18. A system of monitoring location, condition and status of cargo loaded on tray pallets comprising:
(a) supplying one or more tray pallet to a manufacturing location comprising:
one or more tray pallets;
an RFID tag;
an RFID tag reader; and
a portal, wherein a base station monitors the number of tray pallets available for dispensing and automatically supplies one or more additional tray pallet to the manufacturing location as needed, wherein the base station monitors the condition and position of the cargo loaded on the one or more tray pallet;
(b) loading and monitoring the cargo on the one or more tray pallet;
(c) transporting and monitoring the cargo en route to a central shipping location on the one or more tray pallet;
(d) shipping and monitoring the cargo en route to one or more destination site;
(e) unloading the cargo at the one or more destination site; and
(f) monitoring the one or more empty used tray pallet and automatically picking up empty tray pallets as needed.

19. A process for making a tray pallet comprising the steps of:
providing a holder adapted to retain an expanded polymer core, wherein the expanded polymer core contains a deck, a bottom, one or more sides and one or more legs, wherein the holder retains the expanded polymer core by attaching to the deck surface;
retaining the expanded polymer core with the holder, wherein the bottom of the polymer core and the one or more sides of the polymer core and the one or more legs of the polymer core are exposed;
heating a thermoplastic sheet;
stretching the thermoplastic sheet over the bottom of the polymer core and the one or more legs and the one or more sides of the polymer core to a plane P1, where P1 is the plane where the sides of the polymer core intersect the deck of the polymer core and continuing to stretch the thermoplastic sheet to a plane P2, where P2 is distal to P1 and distal to the one or more legs;
joining the corners of the thermoplastic sheet at P2 to form a tray; and
releasing the tray pallet from the holder.

20. The process of claim 19, further comprising embossing the holder such that when the holder is in contact with the polymer core while the thermoplastic sheet is being stretched over the polymer core a depression is left in the polymer core.
